(19) United States
(12) Patent Application Publication
(10) Pub. No.: US 2008/0095520 A1
(43) Pub. Date: Apr. 24, 2008

(54) Mapping Udf and Bdfs Extents

(75) Inventors: Pope Ijtsma, Eindhoven (NL); Johannis Friso Rendert Blacquiere, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,607

(22) PCT Filed: Jul. 19, 2005
(86) PCT No.: PCT/IB05/52415

§ 371 Date: Jan. 24, 2007

(30) Foreign Application Priority Data
Jul. 28, 2004 (EP) 04103601.3

(51) Int. Cl. H04N 5/00

(52) U.S. Cl. 386/126

(57) ABSTRACT

The present invention relates to a method of ensuring seamless playback of video files stored as a BDFS (Blu-ray Disc File System) file in a UDF (Universal Disk Format) file system using a UDF and BDFS combination format, said method of seamlessly playing back the video files comprising the step of creating a BDFS extent by mapping it to at least one UDF extent, wherein said mapping is based on rules defined by BDFS.

### FIELD OF THE INVENTION

The present invention relates to a method of ensuring seamless playback of video files stored as a BDFS (Blu-ray Disc File System) file in UDF (Universal Disk Format) file system using a UDF and BDFS combination format. The invention further relates to a computer-readable medium and a storage device, ensuring seamless playback of video files stored as a BDFS (Blu-ray Disc File System) file in UDF (Universal Disk Format) file system using a UDF and BDFS combination format.

### BACKGROUND OF THE INVENTION

Blu-ray, also known as Blu-ray Disc (BD) is the name of a next-generation optical disc format jointly developed by consumer electronics and PC companies. The format was developed to enable recording, rewriting and playback of high-definition television (HDTV). Blu-ray makes it possible to record over two hours of HDTV, or more than 13 hours of SDTV on a 27 GB disc. There are also plans for higher capacity discs that can hold up to 54 GB of data.

While current optical disc technologies such as DVD, DVD-R, DVD+R, DVD-RW, DVD+RW and DVD-RAM use a red laser to read and write data, the new format uses a blue laser instead, hence the name Blu-ray. The benefit of using a blue laser is that it has a shorter wavelength (405 nanometer) than a red laser (650 nanometer), which means that it is possible to focus the laser beam with even greater precision. This allows data to be packed more tightly on the disc and makes it possible to fit more data on the same size disc. Despite the different types of lasers used, Blu-ray Disc recorders can be made backwards compatible with current red-laser technologies and allow playback of CDs and DVDs.

As HDTV becomes more widespread, the consumer demand for recording HDTV programming will increase. Blu-ray was designed with this application in mind and enables direct recording of the MPEG-2 TS (Transport Stream) used by digital broadcasts, which makes it highly compatible with global standards for digital television. This means that HDTV broadcasts can be recorded directly to the disc without any extra processing or quality loss. To handle the increased amount of data required for HDTV, Blu-ray employs a 36 Mbps data transfer rate, which is more than enough to record and playback HDTV while maintaining the original picture quality. In addition, by fully utilizing an optical disc's random accessing features, it is possible to playback video on a disc while simultaneously recording high-definition video.

Blu-ray is expected to replace VCRs and current DVD technology within a few years. The format is also likely to become a standard for PC data storage and high-definition movies in the future.

The present Blu-ray Disc System Description consists of the following parts:

Part 1: The physical format defining the format and properties of the disc

Part 2: File System specifications called Blu-ray Disc File System (BDFS).

Part 3: Video Application specifications.

The physical format of the disc defines a general disc that is perfectly suited for usage in both the CE and the PC world. The File System and the Video Application specifications (part 2 and part 3) are designed with the CE environment in mind. The first CE devices based on these specifications are already on the market.

The acceptance of the specifications in the PC environment is a different issue, which basically can be linked to the fact that the proposal uses a new defined File System (BDFS). In the PC industry, the number of widely accepted File Systems is rather limited and for optical media the de facto standard is the UDF file system defined by the OSTA. or the usage and commercial success of this format, it is a big disadvantage that the System Description as it is now defined is not acceptable for neither the CE nor the PC industry.

Blu-ray UDF BDFS Combination format has one or more special files distinguished through a file name extension like *.bdv. This “bdv” file serves as a container for the Blu Ray file system books as it is defined for BD RE.

The BDFS file system allocation rules are defined to make sure that recorded video can be played back seamlessly on a BD player. This means that the extents in the BDFS system must have a minimal size. For example, HD recording this is set to 12.5 Mbyte, for DV (Digital Video, e.g. camera recording format) recording this is 25 Mbyte. This is the basic rule. For the first and the last extent of a video sequence there are exceptions.

There is also a reference player defined with given performance parameters for maximum jump times from one extent to another. Together with the allocation rules, this makes seamless playback possible. On the current BD RE disc, BDFS is the only file system on the disc and the file system can make sure that these conditions are met. In the combination proposal, the BDFS container is a file in the UDF file system, which results in a second layer that uses extents. Badly matched UDF and BDFS extents lead easily to non-seamless playback of video.

### OBJECT AND SUMMARY OF THE INVENTION

It is therefore an object to provide a method of avoiding non-seamless playback of video saved in the UDF BDFS combination format. It is therefore of interest to align the UDF and BDFS in such a way that seamless playback of video can be guaranteed as best as possible.

This is obtained by a method of ensuring seamless playback of video files stored as a BDFS (Blu-ray Disc File System) file in UDF (Universal Disk Format) file system using a UDF and BDFS combination format, said method of seamlessly playing back the video files comprising the step of

creating a BDFS extent by mapping it to at least one UDF extent, wherein said mapping is based on rules defined by BDFS.

Thereby playback of video movies is obtained and if sufficient extent length is defined then also simultaneous recording of a stream and playback of another stream is possible.

In an embodiment the method comprises creating UDF extents, said creating of UDF extents being performed based on said rules defined by BDFS. Thereby no additional action is needed to remap the UDF extents to guarantee a seamless playback

In an embodiment the method comprises mapping the BDFS extent to an existing UDF extent, said mapping being based on said rules defined by BDFS.

In an embodiment the mapping is at least based on the BDFS rule defining the minimum size of an extent in BDFS, whereby a BDFS extent is only mapped to a UDFS extent having at least said minimum size. Thereby only a minimum UDF extent size is needed and a BDFS extent can be split into more than one UDF extent without affecting the seamless playback.

In an embodiment the mapping of a BDFS extent to a UDF extent, if possible, is performed when said UDF extent is at least the same size as said BDFS extent. Thereby it is avoided to split the BDFS extent into unnecessary small extents

In an embodiment one BDFS extent is mapped to more UDFS extents. Thereby UDF space is not wasted.

The invention further relates to a computer-readable medium comprising data enabling a storage device to perform the method according to claim 1-5.

The invention further relates to a storage device enabling seamless playback of video files stored as a BDFS (Blu-ray Disc File System) file in UDF (Universal Disk Format) file system using a UDF and BDFS combination format, said device comprises: means for creating a BDFS extent by mapping it to a UDF extent, wherein said mapping is based on rules defined by BDFS.

### BRIEF DESCRIPTION OF THE DRAWINGS

In the following, preferred embodiments of the invention will be described referring to the figures, where:

FIG. 1 illustrates the Blu-ray UDF BDFS Combination format,,

FIG. 2 illustrates UDF extents mapped to several BDFS extents in two different ways,

FIG. 3 illustrates one UDF extent mapped to one BDFS,

FIG. 4 illustrates two BDFS extents mapped by fitting it to two UDF extents.

### DESCRIPTION OF PREFERRED EMBODIMENTS

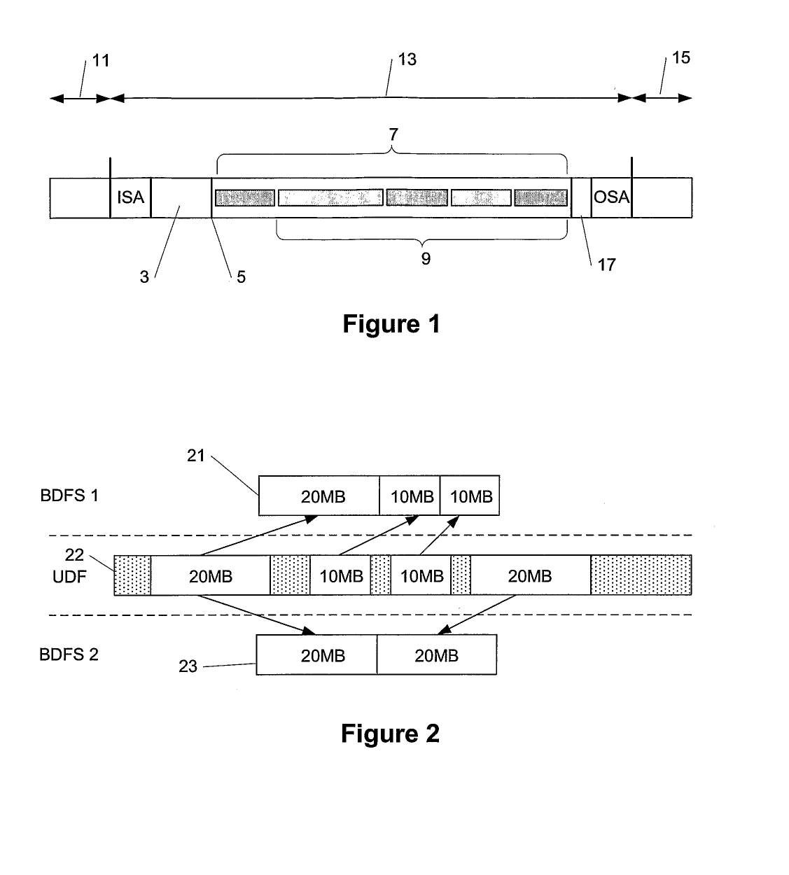

In FIG. 1, a UDF and BDFS combination format is illustrated. Blu-ray UDF BDFS Combination format has one or more special files distinguished through a file name extension like *.bdv. This “bdv” file serves as a container for the Blu-ray file system books as it is defined for BD RE.

The format comprises three zones: first a lead-in zone 11, next a data zone 13 and finally a lead-out zone 15. The data zone 13 comprises a block 3 with a UDF anchor and partition information, after that the UDF partition starts in 5. The UDF file system information and file data are shown as 7 and it comprises a special file 9 with BDFS content. At 17, the UDF partition ends.

According to the present invention in order to obtain seamless playback of video, the UDF and BDFS extents should be matched as good as possible. Both file systems should, when they allocate their extents, take into account the extent sizes of the other file system to preserve the BDFS allocation rules as best as possible.

One way of doing this is to create UDF extents. These UDF extents should be created such that an optimal match between the UDF extents and the BDFS extents is possible in a way that the BDFS allocation rules are maintained as much as possible.

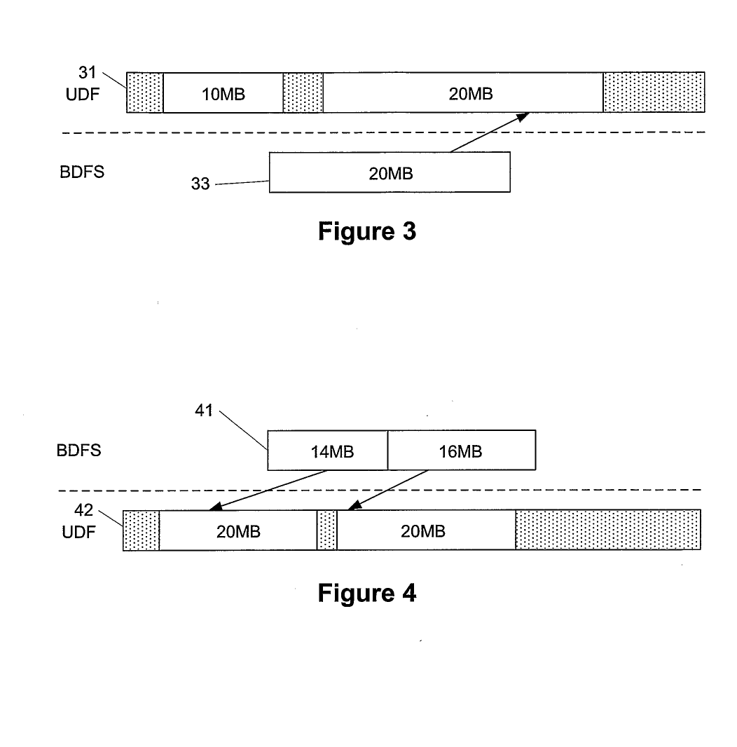

This is illustrated in FIG. 2 and 3. The BDFS file in this example has a size of 40 Mbyte.

In FIG. 2 BDFS 1 21 this is achieved by using the 20 Mbyte extent and the 2×10 Mbyte free space areas from UDF 22. Seamless playback is in that case not assured because an extra jump on UDF level is needed to jump from the first 10 Mbyte extent to the second 10 Mbyte extent. The extent size of only 10 MB is a violation of the BD allocation rules where the minimal extent size should be 12.5 Mbyte for seamless playback (shown in BDFS 1)

The solution to this problem is illustrated in FIG. 2 as BDFS 2 23 and is to use the two largest extents of 20 Mbyte (see BDFS 2 in FIG. 2). This presents no problems because a jump occurs only after 20 Mbyte.

Another simpler example is the situation in FIG. 3. In this case the BDFS volume needed 33 is 20 Mbyte, and we have on the UDF level a 10 Mbyte and a 20 Mbyte free space area. In this example the BDFS volume 33 is mapped onto an extent in the UDF level 31 that is created in the largest free space area (20 MB) and no jumps are needed on the UDF level, guaranteeing seamless playback. This is not the case when the first 10 Mbyte extent is used and 10 Mbyte of the second 20 Mbyte extent.

In FIG. 4 the BDFS volume 41 has two extents; this could for example be two clips or files. The BDFS volume uses the 2×20 Mbyte extent of UIDF to form the volume. Seamless play is achieved by mapping the first 14 Mbyte to extent A in UDF 42 and the second 16 Mbyte to extent B in UDF. This prevents a jump after 6 MB of the second extent (of 16 MB) has been played.

Two examples of performing this mapping could be:

### A) The UDF file system has an allocation API (Application interface), which gives the possibility to force on UDF the extents and sizes it has to create for the file that will be written.

Thereby the following steps are performed from the host point:
1. Create file
2. Set end-of-file (given the file size)
3. Use the allocation API to set the extents needed
4. Write the file

### B) Just write the file to the media, and then rearrange the extents as is appropriate according to the techniques described above.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of ensuring seamless playback of video files stored as a BDFS (Blu-ray Disc File System) file in UDF (Universal Disk Format) file system using a UDF and BDFS combination format, said method of seamlessly playing back the video files comprising the step of:
creating a BDFS extent by mapping it to at least one UDF extent, wherein said mapping is based on rules defined by BDFS.

2. A method according to claim 1, wherein said method comprises creating UDF extents, said creating of UDF extents being performed based on said rules defined by BDFS.

3. A method according to claim 1, wherein said method comprises mapping the BDFS extent to an existing UDF extent, said mapping being based on said rules defined by BDFS.

4. A method according to claim 1, wherein said mapping is at least based on the BDFS rule defining the minimum size of an extent in BDFS, whereby a BDFS extent is only mapped to a UDFS extent having at least said minimum size.

5. A method according to claim 1, wherein, if possible, the mapping of a BDFS extent to a UDF extent is performed when said UDF extent is at least the same size as said BDFS extent.

6. A method according to claim 1, wherein one BDFS extent is mapped to more UDFS extents.

7. A computer-readable medium comprising data enabling a storage device to perform the method according to claim 1.

8. A storage device enabling seamless playback of video files stored as a BDFS (Blu-ray Disc File System) file in UDF (Universal Disk Format) file system using a UDF and BDFS combination format, said device comprises:
means for creating a BDFS extent by mapping it to a UDF extent, wherein said mapping is based on rules defined by BDFS.
